(19) United States
(12) Patent Application Publication
(10) Pub. No.: US 2002/0093993 A1
(43) Pub. Date: Jul. 18, 2002

(54) Apparatus and method for demultiplexing a polarization-multiplexed signal

(76) Inventors: Michael J. LaGasse, Lexington, MA (US); Hemonth G. Rao, Burlington, MA (US); Katherine L. Hall, Westford, MA (US); Morris P. Kesler, Bedford, MA (US)

Correspondence Address: Steven M. Mills, MILLS & ONELLO, LLP, Suite 605, Eleven Beacon Street, Boston, MA, 02108, US

(21) Appl. No.: 10/017,940

(22) Filed: Dec. 14, 2001

Related U.S. Application Data
(63) Continuation-in-part of application No. 09/594,454, filed on Jun. 15, 2000.

(51) Int. Cl. H04J 3/04; H04J 3/02

(52) U.S. Cl. 370/536; 370/542

(57) ABSTRACT

An apparatus and method for demultiplexing a time and polarization multiplexed signal are described. The multiplexed signal is a combination of component signals, each of which is characterized by a polarization. The demultiplexer of the system includes an input interface over which the signal is received. A polarization demultiplexer receives the multiplexed signal and polarization demultiplexes the signal. Next, a time-demultiplexing stage time-demultiplexes the polarization-demultiplexed signal to recover the original component signals. A clock recovery circuit recovers the clock from the polarization-demultiplexed signal before time demultiplexing.

### RELATED APPLICATIONS

This application is a continuation-in-part of copending U.S. application Ser. No. 09/594,454, filed on Jun. 15, 2000, the contents of which are incorporated herein in their entirety by reference.

### BACKGROUND OF THE INVENTION

In many systems such as optical communication systems, it is desirable to transmit and receive streams of data at very high rates. For example, it may be required to forward data at 40 Gigabits per second (40 Gb/s) or even faster. In some settings, such as receiving data streams, electro-optical hardware capable of directly processing data at such high rates is not available. Therefore, various techniques have been developed to accomplish transfer of data at the desired rate while allowing the actual hardware to function within its limitations.

For example, time-division multiplexing (TDM) has been used to combine multiple data streams at relatively slow data rates into a combined stream at a faster overall composite rate. In TDM processing, at the transmitting side, individual bits (or packets of bits) of the component data stream signals are interleaved in time, such as by alternating bit time windows. At the receiving side, by applying controlled timing to the composite signal, the individual component signals can be recovered. To illustrate, two individual 10 Gb/s signals can be combined into a single 20 Gb/s signal by interleaving the bits of the two signals. The receiver can extract alternating bits from the received composite signal to recover the two component signals.

As the demand for faster data rates increases, techniques for multiplexing and demultiplexing data streams must improve in speed and efficiency.

### SUMMARY OF THE INVENTION

In one aspect, the present invention is directed to an apparatus and method for demultiplexing a time-multiplexed signal which permits very high data rates. The demultiplexing system of the invention includes an input interface over which a multiplexed signal, such as, for example, a TDM signal, can be received. The multiplexed signal is a combination of a plurality of component signals, each of which is characterized by a polarization. In one embodiment, at least one modulator receives the multiplexed signal from the input interface and at least partially demultiplexes the signal into at least one or, in one embodiment, a pair of at least partially demultiplexed signals. The at least partially demultiplexed signals are routed toward a plurality of receivers. At least one receiver is adapted to detect signals at an associated respective one of said modulation frequencies. Each receiver provides a feedback signal indicative of an intensity of a received signal at its associated modulation frequency. The feedback signal is used to adjust a parameter of the modulator such that the component signal modulated at the associated modulation frequency can be recovered from the signal received by the receiver.

The modulation signal applied to each component signal is a very low frequency signal relative to the data rate of the component signal. In one particular embodiment, the modulation frequency of one of the component signals is on the order of 10⁻⁷ times the data rate of the component signal. For example, the data rate of each component signal can be 10 Gbits/sec. The modulation frequency can be in the kilohertz range. For example, in one particular exemplary embodiment described herein, the modulation frequencies for each of four 10 Gbits/sec component signals are 1.0 kHz, 1.1 kHz, 1.2 kHz and 1.3 kHz. In one embodiment, the modulation depth is below 100 percent. In one particular embodiment, the modulation depth is below 10 percent and can be, for example 1 percent or 2 percent.

In one embodiment, the modulator is an electro-optical (EO) modulator and, in one particular embodiment, is a Y-fed balanced bridge intensity modulator. The modulator can be a 1×2 modulator having a single input and two outputs. The modulator includes a bias input which adjusts the modulator output based on the applied bias voltage. The feedback signal from the receiver can be used to adjust the bias port of the modulator and/or the RF phase at an RF input port of the modulator. These adjustments are made such that signals having the modulation associated with the receiver are routed out of a first output of the modulator toward the receiver, and other signals are routed out of a second modulator output toward a different receiver.

The demultiplexer of the invention can include multiple EO modulators configured to demultiplex the multiplexed signal in multiple stages. In one embodiment, the signal is demultiplexed in two stages. A first stage includes a single modulator which receives the multiplexed signal and at least partially demultiplexes the signal into a pair of partially demultiplexed signals to partially demultiplex the signal. For example, where the multiplexed signal is a 40 Gb/s signal formed by multiplexing four 10 Gb/s signals, the first stage modulator can demultiplex the multiplexed signal into two 20 Gb/s signals. The partially demultiplexed signals are routed from the outputs of the first-stage modulator to a respective pair of second-stage modulators. Each of the second-stage modulators further demultiplexes its input signal into another pair of further demultiplexed signals. In the example above, each second-stage modulator demultiplexes its 20 Gb/s input signal into a pair of 10 Gb/s demultiplexed signals. These demultiplexed signals generated by the second-stage modulators are forwarded to the receivers associated with their respective modulation frequencies.

Hence, in the system of the invention, the multiplexed signal is formed by applying a different modulation at a unique modulation frequency to each of a group of component signals and then combining the modulated component signals. The modulation applied to each component signal serves to uniquely identify the component signal. The demultiplexer includes multiple receivers, each of which is tuned to one of the modulation frequencies used to create the multiplexed signal. Feedback from one or more of the tuned receivers is used to set up the modulators to route the component signals to the appropriate receivers as they are recovered from the multiplexed signal by the modulators.

The system can be set up or turned on in a very efficient fashion. First, a first turn-on or set-up signal is activated at one of the modulation frequencies. The signal is applied to the first-stage modulator which splits the signal and routes the split signals to the second-stage modulators which split the signals again. The second-stage modulators route the further split signals toward the receivers. The receiver that is tuned to the selected modulation frequency of the first turn-on signal provides a feedback signal which is used to adjust the first-stage and second-stage modulators associated with the receiver. The bias input signals and/or the RF phase at the RF inputs of the modulators are adjusted to maximize the intensity of the signal received by the receiver tuned to the turn-on signal modulation frequency. When this condition is achieved, the receiver is “locked” to incoming signals at the associated modulation frequency. Both the associated first-stage and second-stage modulators route all of the energy at the modulation frequency out of a first output and route other signals out of the second output.

This process is then repeated for another of the receivers. A second turn-on signal at another of the modulation frequencies is applied to the first-stage modulator. The signal at the second modulation frequency is routed out of the second output of the first-stage modulator toward the second-stage modulator, which splits the signal and routes the split signals toward the final two receivers. The one of the receivers that is tuned to the turn-on signal modulation frequency provides the feedback signal used to adjust the bias input and the RF phase input of the associated second-stage modulator. The bias input and RF phase of the RF input are adjusted by the feedback signal to maximize the intensity of the signal at the second modulation frequency at the associated second receiver. As a result, the second receiver is “locked” to the second modulation frequency. After the first two receivers are thus locked to the first two modulation frequencies, the remaining signals at the remaining modulation frequencies are routed automatically through the first and second modulator stages to their appropriate receivers.

In a second aspect, the invention is directed to an apparatus and method for demultiplexing a multiplexed signal. In this aspect, the multiplexed signal is a combination of component signals, each of which is characterized by an optical polarization. The apparatus of the invention includes an input interface over which the polarization-multiplexed signal can be received. At least one polarization demultiplexing unit receives the polarization-multiplexed signal from the interface and generates from the multiplexed signal at least one polarization demultiplexed signal of a first polarization. In one embodiment, a clock recovery circuit receives the polarization-demultiplexed signal and recovers from it a clock signal. The clock signal is used as a means for generating a feedback signal. The feedback signal is used to adjust the polarization demultiplexer to optimize the polarization demultiplexing function. Hence, in this aspect of the invention, the clock is recovered from one of the polarization demultiplexed signals after polarization demultiplexing takes place. The clock signal is used to generate feedback to control the polarization of the input signal such that the polarization demultiplexing can be optimized.

In one embodiment, the multiplexed signal is also a time-division multiplexed (TDM) combination of the component signals, in accordance with the foregoing description. Specifically, the TDM signal can be an optical TDM signal. The signal is also cross-polarization multiplexed, that is, adjacent bits within the TDM bit stream have different, e.g., orthogonal, polarizations.

In one embodiment, the polarization-demultiplexer includes a polarization beam splitter (PBS). The PBS receives the TDM signal and at least partially demultiplexes the signal according to the alternating polarizations of adjacent bits. Component bit streams of a first polarization are provided at the first output of the PBS, and component bit streams of the second, i.e., orthogonal polarization are provided at a second output of the PBS. The polarization-demultiplexed signals are applied to the component bit streams by a polarization transformer which can be of the type described in copending U.S. patent application Ser. No. 09/881,508, filed on Jun. 14, 2001, entitled, “Multi-stage Polarization Transformer,” which is incorporated herein its entirety by reference. The clock signal is recovered from one of the at least partially polarization demultiplexed signals at one of the outputs of the PBS. The at least partially demultiplexed signal is used to generate an error signal which is used along with the recovered clock by a polarization processor to generate a control signal. The control signal is used to control the polarization transformer to adjust the polarization applied to the individual component bit streams. The adjustment to the polarization transformer is made to maximize the error signal at the clock rate frequency. When this is accomplished, the polarization of the component bit stream signals is optimized. For example, in the case illustrated above where the input stream is a 40 Gb/s composite signal made of four TDM 10 Gb/s component signals, the first stage of demultiplexing accomplished by the polarization multiplexer results in two 20 Gb/s bit streams. The clock frequency used to generate the error signal used to adjust the polarization beam splitter is therefore 20 GHz. When the error signal at 20 GHz is maximized the polarization is optimized.

In one embodiment, the polarization demultiplexing is a first stage in a multiple-stage demultiplexing approach. In one particular embodiment, the second stage of demultiplexing is a time-division demultiplexing analogous to the time-division demultiplexing of the aspect of the invention described above. That is, the first stage polarization demultiplexing, in one embodiment, generates two polarization-demultiplexed signals. Each of these partially demultiplexed signals is routed to the second stage time-division demultiplexing, where each of these signals is further demultiplexed into two time and polarization-demultiplexed signals, which can be the recovered original component signals.

The time demultiplexing stage can include one or more EO modulators as described in accordance with the first aspect of the invention above. Each EO modulator can be a 1×2 modulator having a single input and two outputs. Each EO modulator can be a Y-fed balanced bridge intensity modulator. As described above, each EO modulator includes an RF input and a bias input. In one embodiment, the time demultiplexing is accomplished by generating an error signal from the time and polarization demultiplexed signal out of the time multiplexing stage. The error signal is used to generate feedback control used to adjust and optimize the time multiplexing stage. The clock recovery circuit, in addition to generating the 20 GHz recovered clock signal at the output of the polarization demultiplexing stage, also generates a signal at a higher-order harmonic or sub-harmonic frequency of the 20 GHz clock signal. In one embodiment, this second recovered clock signal is recovered at a sub-harmonic frequency and, in one particular embodiment, is at the frequency equal to the data rate of the individual component signals, e.g., 10 GHz. This second recovered clock signal is routed to a phase shifter. The error signal from the output of the EO modulator is used by a feedback processor to adjust the phase shifter to generate a phase-shifted version of the second recovered clock signal. This phase-shifted version of the second recovered clock signal is applied to the RF input of the EO modulator to adjust the EO modulator to optimize the time-demultiplexing function.

In one embodiment, the feedback processor in the time-demultiplexing stage applies a periodic fluctuation or dither to the phase of the second recovered clock signal via the phase shifter. The period of the dither can be very slow, e.g., on the order of 1 kHz. In this embodiment, the detector which generates the error signal includes a photodetector and amplifier tuned to the dither frequency, i.e., about 1 kHz. The resulting error signal is a signal at the dither frequency. The phase at the phase shifter is adjusted in addition to the phase dither to minimize the error signal and thereby optimize the time demultiplexing. In one particular version of this embodiment, the feedback processor also provides a bias input to the EO modulator which slightly perturbs the bias of the EO modulator from quadrature such that the error signal at the dither frequency can reliably be generated.

In another embodiment, the detector circuit for generating the error signal includes high-frequency RF detection circuits for generating the error signal at a frequency equal to the bit rate of the time-demultiplexed components, e.g., 10 GHz. In this embodiment, the feedback processor adjusts the phase of the clock signal applied to the RF input of the EO modulator to maximize the power of the high-frequency RF error signal.

In another embodiment, the error signal generating detection circuitry includes a processor at the output of the time-demultiplexing stage which decodes the data in the component signals to read error correction codes carried with the data. The error detection codes can be forward error correction (FEC) information. Bit error rate (BER) can be monitored while the slow phase dither is applied by the feedback processor and the phase shifter to the second recovered clock signal at, for example, 10 GHz. The generated error signal tracks the change in BER over time. The feedback processor controls the phase shifter to alter the phase of the second recovered clock signal to maximize the match between the periodic dithering of the phase and the resulting fluctuation in BER. Alternatively, the FEC statistics can be monitored and the phase of the second recovered clock signal adjusted to minimize BER. In this case, no periodic phase dither need be applied.

Hence, the demultiplexing receiving system of the invention can be regarded as a multiple-stage, multiple-mode receiver. In the first stage, a high-bit-rate, e.g., 40 Gb/sec, signal is received. The received signal is a cross-polarization multiplexed combination of two intermediate-bit-rate, e.g., 20 Gb/s, signals, having orthogonal polarizations. Each of the intermediate-bit-rate signals is a time-multiplexed combination of two component-bit-rate, e.g., 10 Gb/s, signals. In the first stage of the receiver, polarization demultiplexing splits the incoming high-bit-rate signals into the two intermediate-bit-rate signals, according to their polarizations, using a polarization beam splitter and a polarization transformer. This polarization demultiplexing stage is controlled by a clock signal recovered at the output of the polarization demultiplexing stage. This intermediate clock signal, having a frequency at the intermediate bit rate, e.g., 20 GHz, is generated by a clock recovery circuit and is processed to optimize the polarization demultiplexing in the first stage of the receiver. In one embodiment, the 20 GHz component of the recovered intermediate clock signal is maximized by adjusting the polarization transformer receiving the high-bit-rate (40 Gb/s) input signal. When the 20 GHz signal is maximized, the polarization demultiplexing of the first stage is optimized.

The clock recovery circuit can also generate another clock signal used to control the second stage of demultiplexing, i.e., the time demultiplexing. This second recovered clock signal can be a harmonic or sub-harmonic of the clock of the intermediate bit-rate signal. In one embodiment, the second recovered clock signal has a frequency of one-half the bit rate of the intermediate bit-rate input signal, e.g., 10 GHz. This second recovered clock signal is used to adjust the EO modulators in the time-demultiplexing second stage of the receiver. The phase of the second recovered clock signal is adjusted, and the phase-adjusted version of the signal is applied to the RF input of the EO modulators to optimize the time demultiplexing performed in the second stage in accordance with the description herein.

In accordance with the invention, the above described polarization demultiplexing and time-division multiplexing can be accomplished using set-up or turn-on signals to “lock up” the receiver to the optical and time-division multiplexed signals being received. To ensure that the correct component signals are being routed to the correct outputs, the component signals can have identifying data encoded within them. This data can include FEC information. In this embodiment, at the outputs of the receiver, each recovered component data stream is analyzed to determine if it has been routed to the correct output. These identifying bit streams can be used to correct both incorrect polarization demultiplexing in the first stage as well as incorrect time demultiplexing in the second stage. Where the decoded identifying bits indicate that the polarization demultiplexing is not being performed properly, the outputs of the PBS can be flipped by rotating the polarization at the polarization transformer orthogonally or to an orthogonal state. This is usually accomplished by resetting the polarization transformer and allowing it to start up again, relying on the relative randomness of the initialization of the polarization. Statistically, the PBS should route the bit stream correctly within only a few trials and resets. In the time demultiplexing stage, if the identifying bit streams indicate that the time demultiplexing is not being performed properly, the feedback processor can apply a 180 degree phase shift to the second recovered clock signal applied to the RF input of the EO modulator via the phase shifter. These approaches will ensure that the receiver routes the correct recovered time and polarization demultiplexed component signals to their appropriate receiver outputs.

### BRIEF DESCRIPTION OF THE DRAWINGS

The foregoing and other objects, features and advantages of the invention will be apparent from the following more particular description of preferred embodiments of the invention, as illustrated in the accompanying drawings in which like reference characters refer to the same parts throughout the different views. The drawings are not necessarily to scale, emphasis instead being placed upon illustrating the principles of the invention.

FIG. 1 contains a schematic block diagram of one embodiment of a demultiplexing system in accordance with the present invention.

FIG. 2 contains a schematic diagram illustrating one type of signal time multiplexing to which the present invention is applicable.

FIG. 3 contains a schematic flowchart which illustrates the logical flow of a turn-on procedure for the system of the invention in accordance with the invention.

FIG. 4 contains a schematic block diagram of an embodiment of a demultiplexing system in accordance with a second aspect of the present invention.

FIG. 5 contains a schematic diagram illustrating one type of cross-polarization multiplexing of component signals to generate a time and polarization multiplexed signal which can be demultiplexed in accordance with the invention.

FIG. 6 contains a schematic functional block diagram of one embodiment of an error signal generating detection system in accordance with the invention.

FIG. 7 contains a schematic functional block diagram of another embodiment of an error signal generating detection system in accordance with the invention.

### DETAILED DESCRIPTION OF PREFERRED EMBODIMENTS OF THE INVENTION

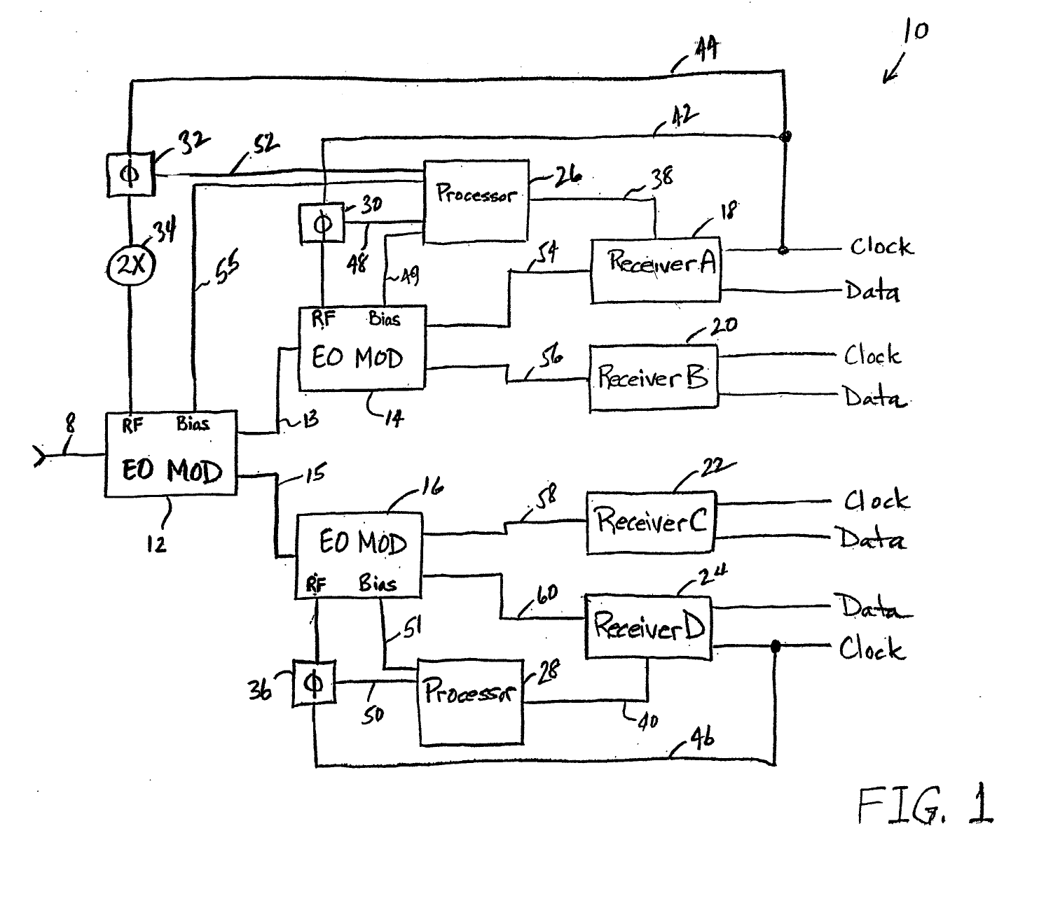

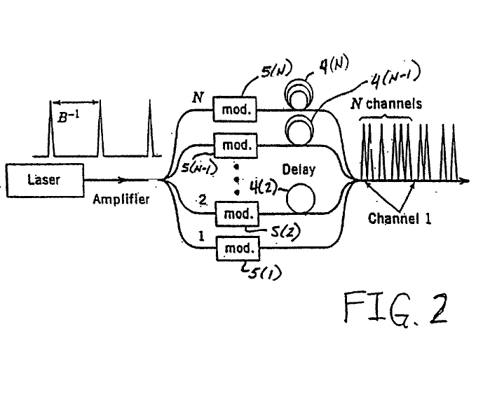

FIG. 1 is a schematic block diagram of one embodiment of a demultiplexing system 10 in accordance with the present invention. A time-multiplexed signal is received at an input interface 8. FIG. 2 is a schematic diagram which generally illustrates one form of time multiplexing which can be used to generate the time-multiplexed signal to which the invention is applicable. Referring to FIG. 2, a technique for multiplexing N channels or signals is illustrated. Multiplexing of the N bit streams is achieved by a delay technique. The laser 2 generates a periodic pulse train at the repetition rate equal to the single-channel bit rate B. In this illustration, the pulse train output is split into N branches, after amplification if necessary, and a modulator 5(1), 5(2), . . . , 5(N) in each branch blocks the pulse for every 0 bit, creating N independent bit streams at the bit rate B.

In one embodiment, each of the individual signals in each branch is modulated at a different identifying modulation frequency by modulators 5(1), 5(2), . . . , 5(N). Multiplexing of N bit streams is achieved by individually set delays 4(1), 4(2), . . . , 4(N) in each branch. The modulated bit stream in the nth branch is delayed by an amount (n−1)/(NB), where n=1, . . . , N. The outputs of all the branches are combined to form a composite signal. In one embodiment, the multiplexed signal is a combination of four (N=4) 10 Gb/s (B=10 Gb/s) signals. Hence, the composite signal bit rate is 40 Gb/s. Specifically, the time-multiplexed signal to which the present invention is applicable can be generated by a transmission and multiplexing system such as the one described in copending U.S. patent application Ser. No. 09/566,303, filed on May 8, 2000, entitled, “Bit Interleaved Optical Multiplexer,” of the same assignee as the assignee of the present application. The contents of that application are incorporated herein in their entirety by reference.

Referring again to FIG. 1, the multiplexed signal is routed from the input 8 to the input of a first 1×2 EO modulator 12. First and second outputs of the first modulator 12 are routed on lines 13 and 15, respectively, as shown to the inputs of a second 1×2 EO modulator 14 and a third 1×2 EO modulator 16, respectively. In one embodiment, each of the 1×2 EO modulators is a Y-fed balanced bridge modulator, or the like, such as those manufactured and sold by J D S Uniphase Corporation.

The first modulator 12 receives the multiplexed signal from the input 8 and partially demultipexes the signal into two partially demultiplexed signals. The first output signal from the modulator 12 is provided on line 13 as the input to a second modulator 14. The second output of the modulator 12 is provided on line 15 to the input of the third modulator 16. The modulator 14 further demultiplexes its received signal into two demultiplexed signals and routes its first and second demultiplexed outputs on lines 54 and 56 to receivers 18 and 20, respectively. Similarly, the modulator 16 further demultiplexes its input signal into two demultiplexed signals and routes its first and second demultiplexed output signals on lines 58 and 60 to the receivers 22 and 24, respectively.

As described above, in one embodiment, each component signal in the multiplexed signal is characterized by a unique modulation frequency which serves to identify and distinguish the component signal from the other component signals. This unique modulation is used by the system 10 to recover the component signals. To that end, each receiver 18, 20, 22 and 24 is tuned to a particular modulation frequency. To aid in description of the invention, the modulations will be referred to herein as A, B, C and D. Hence, receiver 18 is tuned to detect signals with modulation A, receiver 20 is tuned to detect signals with modulation B, receiver 22 is tuned to detect signals with modulation C, and receiver 24 is tuned to detect signals with modulation D.

In one embodiment, the modulation signal applied to each component signal is a very low frequency signal relative to the data rate of the component signal. In one particular embodiment, the modulation frequency of one of the component signals is on the order of 10⁻⁷ times the data rate of the component signal. For example, the data rate of each component signal can be 10 Gb/sec. The modulation frequency can be in the kilohertz range. In one illustrative embodiment, the modulation frequencies of the component signals can be as follows: A=1.0 kHz; B=1.2 kHz; C=1.3 kHz; D=1.1 kHz. It will be understood that these frequencies are chosen for illustration purposes only. Other frequencies may be chosen. Also, the modulation depth of the signal can be below 100 percent. In one embodiment, the modulation depth is below 10 percent and can be, for example 1 percent or 2 percent.

Each of the receivers 18, 20, 22 and 24 includes detection circuitry used to detect its respective associated subcarrier modulation to recover the data at its incoming component data rate, e.g., 10 Gb/s. The data is recovered from the signal, and a clock signal having a frequency at the data rate is generated from the incoming data. As shown in FIG. 1, in the described embodiment, receiver 18 generates a clock signal from the recovered data stream, and feeds back the clock signal to a pair of phase shifters 30 and 32 on lines 42 and 44, respectively. A processor 26 uses a signal indicative of the intensity of the modulation A signal received at the receiver 18 to generate a phase control signal used to control the amount of phase shift in phase shifter 30 and provides the control signal to phase shifter 30 on line 48. The processor 26 also generates another phase control signal used to control the amount of phase shift in phase shifter 32 and provides the control signal to phase shifter 32 on line 52. These phase shifted signals are applied to the RF inputs of the modulators 12 and 14 to precisely control the delay of the signals through the modulators such that the component signals can be accurately recovered from the multiplexed composite signal. It should be noted that the frequency of the signal fed back to modulator 12 is doubled by frequency doubler 34 because the modulator 12 operates to generate the partially demultiplexed signals on lines 13 and 15 at twice the frequency at which the modulator 14 operates.

Receiver 24 also generates a feedback clock signal and provides the feedback signal to phase shifter 36. The processor 28 generates another phase control signal and applies the control signal via line 50 to phase shifter 36 to control the phase shift introduced into the feedback clock signal. Once again, this is done to control the timing of the demultiplexing process of the invention.

Receiver 18 also provides a feedback signal on line 38 which is indicative of the intensity of received signal having modulation A. The feedback signal is routed to the processor 26 which uses the feedback signal to generate the control signals used to adjust the bias input and the RF phase at the RF input of the modulator 14. The bias input control signal is routed to the bias input of the modulator 14 on line 49. The RF phase control signal is routed to the phase shifter 30 on line 48. The 10 GHz clock signal recovered by the receiver 18 is routed on line 42 to the phase shifter 30. The control signal from the processor 26 on line 48 controls the phase shift of the clock signal introduced by the phase shifter 30. The phase shifted clock signal is applied to the RF input of the modulator 14. The bias input and RF inputs are adjusted to maximize the intensity of the modulation A signal at the receiver 18. As a result, all signal with modulation A received by the modulator 14 is routed via the first output of the modulator 14 on line 54 to receiver 18. The remaining signal is routed via the second output of modulator 14 on line 56 to receiver 20. As will be described below, when the system 10 is operating, this remaining radiation will only be signal with modulation B.

The processor 26 also generates control signals used to control the bias input and the RF input to the first modulator 12. The second bias control signal is applied to the bias input of modulator 12 via line 55, and the second phase control signal is applied to the phase shifter 32 via line 52. The phase shifter 32 adjusts the phase of the 10 GHz clock signal recovered by the receiver 18 and applies the phase shifted clock signal through the frequency doubler 34 to the RF input of the modulator 12. Again, the bias input and RF input to modulator 12 are adjusted to maximize the modulation A signal intensity at receiver 18. Because of the selection of modulation frequencies and the timing and positioning of the relevant component signals within the composite signal, modulator 12 routes signals with modulation A and B via its first output on line 13 to modulator 14. The remaining signals, i.e., signals with modulations C and D, are routed via the second output of modulator 12 on line 15 to the third modulator 16. Modulator 16 further demultiplexes its input signal into two demultiplexed output signals. Its first output provides signals with modulation D to receiver 24 on line 60. The second output provides signals with modulation C to receiver 22 on line 58.

Receiver 24 generates a feedback signal related to the intensity of received signal at modulation D and routes the feedback signal to a second processor 28 on line 40. In similar fashion to processor 26, the processor 28 generates a bias control signal on line 51 used to adjust the bias input of modulator 16 and a phase control signal on line 50 used to adjust the RF input of modulator 16. The phase control signal is applied to the phase shifter 36 to adjust the phase of the 10 GHz clock signal recovered by receiver 24. The phase-shifted clock signal is applied to the RF input of modulator 16. The bias control signal and phase control signals are adjusted to maximize the intensity of the modulation D signal at receiver 24. When the intensity of modulation D signal at receiver 24 is maximized, all of the modulation D signal received by modulator 16 is routed via its first output on line 60 to receiver 24. The remaining signal, i.e., signal at modulation C, is routed via the second output on line 58 to receiver 22.

In summary, the first modulator 12 is set up via feedback control to partially demultiplex the incoming multiplexed signal into two partially demultiplexed signals. The first signal at the first output of the modulator 12 includes multiplexed signals of modulations A and B on line 13. The second signal at the second output of modulator 12 includes multiplexed signals of modulations C and D on line 15. The modulator 14 further demultiplexes the partially multiplexed signal on line 13 into two demultiplexed signals having modulations A and B. Likewise, modulator 16 further demultiplexes the signal on line 15 into two demultiplexed signals having modulations C and D. The completely demultiplexed signals are applied to their respective receivers by modulators 14 and 16.

In the illustrative example described herein in which four 10 Gb/s signals are combined into a single 40 Gb/s signal, the signal received at the input of the modulator 12 is a 40 Gb/s signal, being the time-multiplexed composite of the four individual 10 Gb/s signals. The modulator 12 demultiplexes this composite signal into two 20 Gb/s signals, each of which is applied to one of modulators 14 and 16. Each of the modulators 14 and 16 further demultiplexes its incoming 20 Gb/s signal into a pair of 10 Gb/s signals to complete the demultiplexing of the multiplexed input signal. Thus, the demultiplexing of the input signal occurs in multiple stages, in this case, two stages.

It should be noted that in the foregoing description, processors 26 and 28 are described as being separate processors. However, it will be understood that the two processors 26 and 28 can actually be implemented in a single processor device.

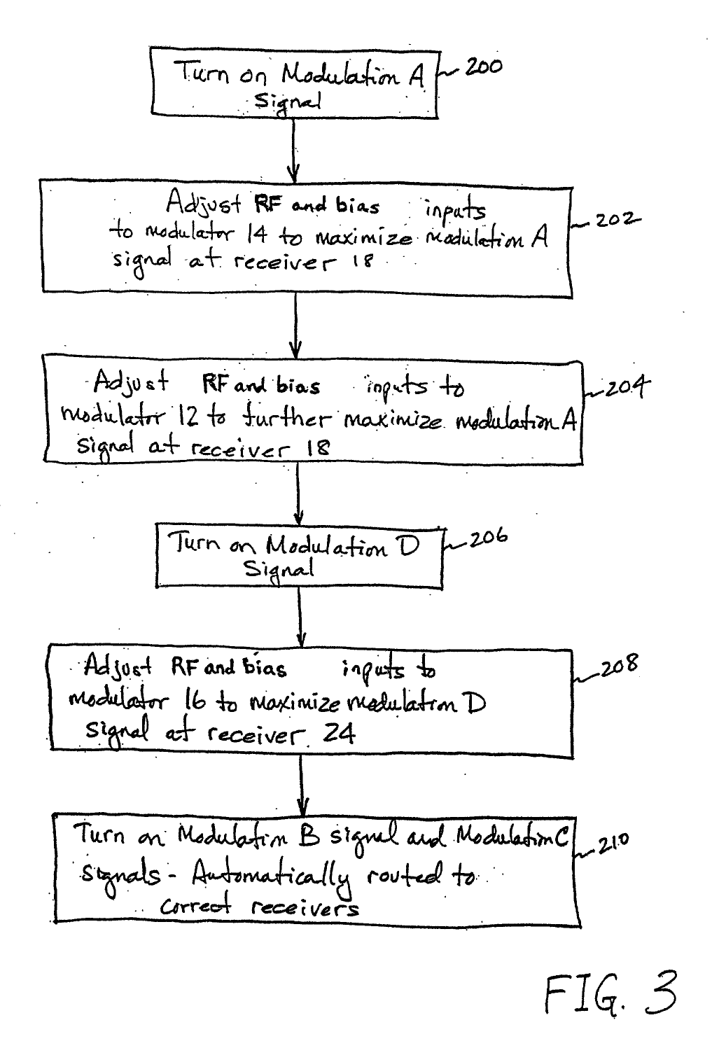

The demultiplexing system 10 of FIG. 1 can be turned on and locked up to the incoming multiplexed signal in an efficient fashion. FIG. 3 contains a schematic flowchart which illustrates the logical flow of a turn-on procedure for the system of the invention in accordance with the invention. Referring to FIG. 3, in a first step 200, a signal having only modulation A is turned on and applied to the input 8 of the system 10. Next, in step 202, the control signals generated by the processor 26 and applied to lines 48 and 49 are adjusted to adjust the RF and bias inputs, respectively, to the modulator 14. These signals are adjusted to maximize the power of the modulation A signal received at the receiver 18. When this power is maximized, modulator 14 is locked in the correct state. It will route all modulation A power to receiver 18 and other power to receiver 20.

Next, in step 204, the control signals generated by the processor 26 and applied to lines 52 and 55 are adjusted to adjust the RF and bias inputs, respectively, to the modulator 12. These signals are adjusted to further maximize the power of the modulation A signal received at the receiver 18. When this power is maximized, modulator 12 is locked in the correct state. It will route signals with power at modulation A and B on line 13 to modulator 14 and other signals to modulator 16 on line 15.

Next, in step 206, a signal with modulation D power is turned on and applied to the system input 8. Because modulator 12 is already locked in the correct state, this modulation D signal will automatically be routed to the modulator 16 on line 15.

Next, in step 208, the control signals generated by the processor 28 and applied to lines 50 and 51 are adjusted to adjust the RF and bias inputs, respectively, to the modulator 16. These signals are adjusted to maximize the power of the modulation D signal received at receiver 24. When this power is maximized, modulator 16 is locked in the correct state. It will route signals with power at modulation D on line 60 and all other signals, e.g., signals with power at modulation C, to receiver 22.

Finally, in step 210, signals with modulations B and C are turned on and applied to system input 8. Because all of the modulators 12, 14 and 16 are set up and locked in their correct states, signals with these remaining two modulations are routed automatically to their respective appropriate receivers. That is, signals with modulation B are routed to receiver 20, and signals with modulation C are routed to receiver 22.

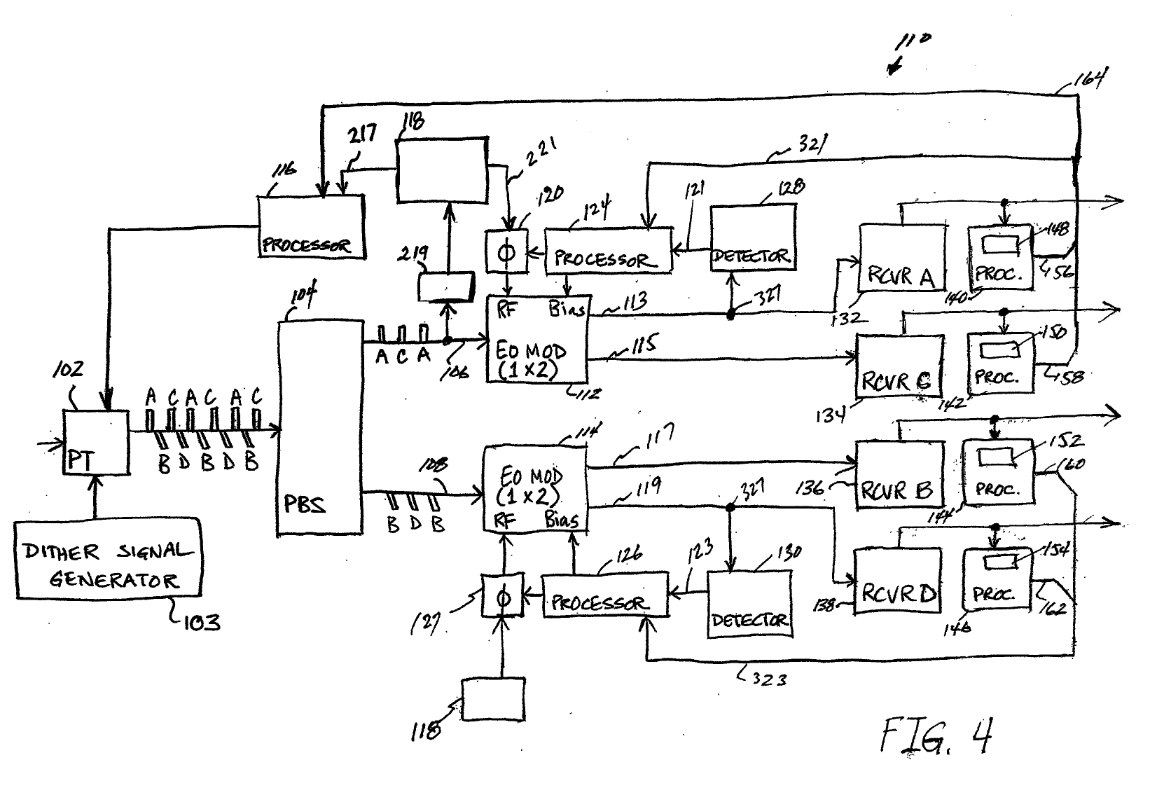

FIG. 4 contains a schematic block diagram of one embodiment of a demultiplexing and receiving system 110 in accordance with a second aspect of the invention. This receiving and demultiplexing system 110 is analogous to the system 10 described above in that two stages of demultiplexing are realized. In the system 10 described above, two stages of time demultiplexing using EO modulators are implemented. In the system 110 of FIG. 4, two stages of demultiplexing are implemented. However, a first stage of demultiplexing is polarization demultiplexing and the second stage is, like the embodiment described above, time demultiplexing. In this embodiment of the invention, the input signal is not only time-division multiplexed (TDM) but it is also polarization multiplexed.

The input TDM signal which, in one embodiment, is an optical TDM (OTDM) signal, is received at a polarization transformer 102. The input OTDM signal can be generated in accordance with copending U.S. patent application Ser. No. 09/566,303, filed on May 8, 2001, entitled, “Bit Interleaved Optical Multiplexer,” and copending U.S. patent application Ser. No. 09/782,569, filed on Feb. 13, 2001, entitled, “Polarization Division Multiplexer.” The contents of both applications are incorporated herein in their entirety by reference.

In general, as illustrated in FIG. 4 the OTDM signal can be a bit-interleaved time-multiplexed combination of a plurality of component signals. In the illustrations throughout this application and again in FIG. 4, the OTDM signal is a combination of four signals referred to as signals A, B, C and D. The bit streams are interleaved in time such that they are combined in the order A, B, C, D. In accordance with this embodiment of this invention, alternating streams have different polarizations applied to them by the polarization transformer and transmitter 102. That is, bit streams A and C have a first polarization applied, and bit streams B and D have a second orthogonal polarization applied to them. The result is that adjacent bits in the composite bit stream have orthogonal polarizations.

The OTDM signal is applied to the polarization transformer 102. Numerous types of polarization transformers can be used with the present invention. For example, the polarization transformer 102 may be an electro-optic, electro-ceramic, magneto-optic, material deformation induced, and liquid crystal-type polarization transformer. In one embodiment, the polarization transformer 102, is the type that is described in co-pending U.S. patent application Ser. No. 09/881,508, filed on Jun. 14, 2001, entitled, “Multi-Stage Polarization Transformer,” the contents of which are incorporated herein their entirety by reference.

The polarization transformer 102 may include retardation waveplates. The retardation waveplates can be generally characterized as fixed retardation, i.e., fixed thickness, and variable angle, fixed angle and variable retardation, i.e., variable thickness, or a combination of both fixed retardation and variable angle and fixed angle and variable retardation. Polarization transformers that use retardation waveplates of fixed retardation and variable angle are advantageous because they can achieve rewind free operation. Rewind is defined herein as reconfiguring or rewinding the polarization transformer drivers so that the processor 116 generates drive voltages that are within the normal operating range of the polarization transformer. Rewinds are undesirable because they reduce the response time of the transformer and can result in an unacceptable loss of data. In one embodiment, the polarization transformer 102 operates rewind free in the normal range of operation.

Retardation waveplates having fixed retardation and variable angle can be mechanically rotated waveplates in bulk optic or fiber optic form. Mechanically rotated waveplates, however, have inherently slow control speeds (on order of hundreds of milliseconds) and are not suitable for use in high-speed optical communication systems. Retardation waveplates having fixed retardation and variable angle can also be electro-optically induced retardation waveplates in bulk optic or integrated-optic form. Electro-optically induced retardation plates have relatively fast control speed and can be used in high-speed optical communication systems.

One type of known electro-optically induced polarization transformer that can be configured as retardation waveplates having fixed retardation and variable angle is a lithium niobate polarization transformer. Waveguides are formed in a lithium niobate substrate. For example, z-propagating waveguides can be formed in x-cut lithium niobate by titanium diffusion. Electrodes are formed on the top of the substrate to create retardation waveplate stages. Lithium niobate polarization transformers are advantageous because they have relatively fast response times and have relatively low drive voltages. Also, lithium niobate polarization transformers can provide endless polarization control and rewind free operation.

Lithium niobate polarization transformers are typically configured to operate as a series of cascaded retardation waveplates. Each of the series of cascaded waveplates is biased to achieve a certain angle and magnitude of the birefringment axes. In one embodiment, the polarization transformer 102 includes a series of five or more cascaded retardation quarter-wave waveplates.

Polarization transformers that use endlessly rotatable retardation plates, such as lithium niobate polarization transformers, can be operated with a relatively simple and fast control algorithm because they do not require rewind or reset cycles. In one embodiment, a step dither or synchronous demodulation algorithm is used to control the polarization transformer 102 so that it generates the desired state of polarization. Step dither and synchronous demodulation algorithms are known in the art.

In this embodiment, a dither signal generator 103 is electrically connected to an electrical input of the polarization transformer 102. The dither signal generator is used to produce a dither signal for modulating the polarization state of the transformed optical signals. The modulated signal is detected and then processed to generate an error signal. The error signal is fed back to the polarization transformer 102.

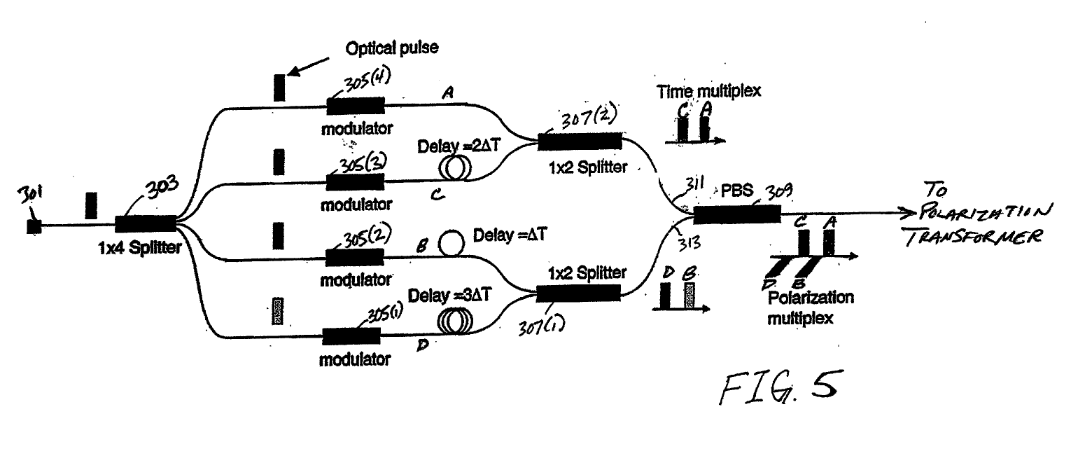

FIG. 5 contains a schematic diagram illustrating one type of cross-polarization multiplexing of N, e.g., four, component signals to generate a time and polarization multiplexed signal which can be demultiplexed in accordance with the invention. In accordance with this embodiment, a stream of optical pulses at the maximum repetition rate of the component signal, e.g., 10 Gb/s, is generated by a laser 301 and applied to a 1×4 splitter. The signal is split into four signals composed of streams of optical pulses. Each pulse stream is applied to a respective modulator 305(1), 305(2), 305(3) and 305(4), which applies the data to the bit stream by blocking pulses for zero bits and passing pulses for one bits.

The individual bit streams are then interleaved in time, i.e., time multiplexed, by introducing a different amount of time delay into each stream. In one embodiment, the delay introduced into each stream is a multiple of a unit delay time ΔT. In the embodiment of FIG. 5, the first and second streams from modulators 305(3) and 305(4) are delayed by even multiples of ΔT. The delay in the first stream is zero times the unit delay (zero delay), and the delay in the second stream is two times the unit delay. The third and fourth streams from modulators 305(2) and 305(1) are delayed by odd multiples of ΔT. The delay in the third stream is one times the unit delay ΔT, and the delay in the fourth stream is three times the unit delay. Each pair of bit stream signals is applied to a 1×2 optical combiner 307(1), 307(2) which generates from each input pair a partially time multiplexed combination of component bit stream signals interleaved in time. The two time-multiplexed signal pairs are then combined and further interleaved in time in a polarization beam splitter (PBS) 309 used as a polarization combiner. As they are combined in the PBS 309, each signal has a particular polarization applied. The first interleaved signal pair received at 311 has a first polarization applied, and the second pair received at 313 has a second orthogonal polarization applied. Because of the selection of the time delays between the signals, the two component partially time-multiplexed signals from the 1×2 combiners 307 include bit windows that are spaced apart in time such that the four original component signals are interleaved in time in the final composite time and polarization multiplexed signal. The resulting time and polarization multiplexed signal is configured such that consecutive bits in the composite signal have orthogonal polarizations.

To illustrate, referring to FIG. 5, modulators 305(4), 305(3), 305(2) and 305(1) can be configured to apply encoded bit steams A, C, B and D, respectively, to their incoming optical pulse streams. 1×2 combiner 307(2) combines stream A with 2× delayed stream C to produce a signal in which streams A and C are interleaved in time. Similarly, 1×2 combiner 307(1) combines 1× delayed stream B with 3× delayed stream D to produce a signal in which streams B and D are interleaved in time. The PBS 309 combines these two interleaved signals to create a completed time-multiplexed signal in which streams A, B, C and D are interleaved in order and appear in order at the output of the transmitter. Streams A and C also have one polarization applied, and streams B and D have an orthogonal polarization applied such that adjacent bits are polarized orthogonally, as shown schematically in FIG. 5.

Referring again to FIG. 4, a time and polarization-multiplexed composite signal of the type output from the polarization transmitter of FIG. 5 is received by the system of the invention and is applied to the polarization transformer 102. As noted above, the received signal can be a high-bit-rate (40 Gb/s) signal formed by time-division and cross-polarization multiplexing four lower-bit-rate (10 Gb/s) component signals. The output of the polarization transformer 102 is applied to a polarization-sensitive device such as a polarization beam splitter (PBS) 104. The PBS 104 performs a first stage of demultiplexing by splitting the input composite signal into two component signals according to the polarization. The bit streams having a first polarization, e.g., bit streams A and C, are provided at a first output of the PBS 104. Bit streams B and D, having the orthogonal polarization, are provided at the second output at the PBS 104. Hence, the first stage of demultiplexing of the composite signal is accomplished by PBS 104 which splits the time and polarization-multiplexed composite signal of four component signals into two intermediate-stage polarization-demultiplexed signals which are each time-multiplexed combinations of two of the original component signals. To illustrate, in accordance with the example described herein, if each of the component signals is a 10 Gb/s signal, the time and polarization-multiplexed composite signal is a 40 Gb/s signal. Each of the intermediate polarization-demultiplexed signals out of the PBS 104 in the first stage of the receiving system of the invention is a 20 Gb/s time-multiplexed combination of two 10 Gb/s component signals. The polarization transformer 102 is controlled to align the polarization to the PBS 104 such that the two output signals on lines 106 and 108 are aligned to their respective 1×2 EO modulators 112 and 114 in the time-demultiplexing stage.

The first-stage polarization demultiplexing is controlled by a polarization processor 116. The polarization processor 116 receives an error signal on line 217 generated from the first output of the PBS 104. The output of the PBS 104 is provided from line 106 to an optical detector 219 which generates an electrical signal from the optical signal out of the PBS 104. This signal is then applied to a clock recovery circuit 118, which generates a clock signal at a frequency equal to the bit rate of the signal from the detector 219. The clock recovery circuit can be of the type described in copending U.S. patent application Ser. No. 09/939,852, filed on Aug. 27, 2001, entitled, “System and Method for Wide Dynamic Range Clock Recovery,” the contents of which are incorporated herein in their entirety by reference. In the illustrative example described herein, the intermediate-rate digital signal is a 20 Gb/s signal which is a time-division multiplexed combination of two 10 Gb/s component signals. The clock recovery circuit 118 generates an intermediate-rate clock signal, e.g., at 20 GHz, from the intermediate-bit-rate digital signals, e.g., at 20 Gb/s, and forwards the intermediate-rate clock signal as an error signal on line 217 to the polarization processor 116. The polarization processor 116 uses the error/recovered clock signal received on line 217 to adjust the polarization transformer 102 to ensure that the polarization demultiplexing is optimized. The error signal can be maximized by adjusting the polarization control voltages applied at the polarization transformer 102 to the component signals. Hence, in this first stage of polarization demultiplexing, the clock signal recovered from the output of the polarization demultiplexing stage is used to generate feedback to control the polarization demultiplexing via the polarization transformer 102. The polarization transformer can be of the type described in copending U.S. patent application Ser. No. 09/881,508, filed on Jun. 14, 2001, entitled, “Multi-stage Polarization Transformer,” incorporated herein by reference above.

The first and second polarization-demultiplexed signals are forwarded to the second stage of demultiplexing on lines 106 and 108. In the embodiment shown in FIG. 4, the second stage of demultiplexing is composed of time demultiplexing carried out by a pair of 1×2 EO modulators 112 and 114. As described above in connection with FIG. 1, the EO modulators 112 and 114 can be Y-fed balanced bridge intensity modulators. The Y-fed balanced bridge modulators can be of the type manufactured and sold by J D S Uniphase Corporation. As described above, each of the modulators 112, 114 includes an RF input and a bias input. A second clock signal recovered by the clock recovery circuit 118 is applied via line 221 through a phase shifter 120 to the RF input of the EO modulator 112. In general, this second recovered clock signal is any harmonic or sub-harmonic of the first recovered clock signal. In one particular embodiment, its frequency is one-half the frequency of the first recovered clock signal; in the example described herein, the frequency of the second recovered clock rate is 10 GHz. By adjusting the phase of the second recovered clock signal applied at the RF input, the time multiplexed combination of the two component bit streams, e.g., A and C, can be demultiplexed in time. One of the component bit streams is provided at a first output of the EO modulator 112 on line 113, and the other bit stream is provided on the second output 115 of the EO modulator 112. In similar fashion, the one-half-rate second recovered clock signal (10 GHz) recovered at the clock recovery circuit 118 is applied to a phase shifter 127. A processor 126 controls the phase shifter 127 to alter the phase of the recovered clock signal applied at the RF input of the EO modulator 114. By tuning the phase of the 10 GHz second recovered clock signal, the amount of signal of the first of the component bit streams, e.g. B or D, can be maximized at the first output 117 of the EO modulator. The other bit stream appears at the second output 119 of the EO modulator 114.

Each of the outputs 113, 115, 117, 119 of the EO modulators 112, 114 is routed to a respective receiver 132, 134, 136, 138. The receivers can decode the information in the individual component bit streams. The data in the bit streams is gathered and processed by processor 140, 142, 144 and 146. In one embodiment, each of the processors includes an error correction data processor 148, 150, 152, 154, respectively, which can be forward error correction (FEC) data processing equipment. The receivers 132, 134, 136, 138 forward their respective data on for further processing. In addition, the data from the receivers is forwarded to the processors 140, 142, 144, 146.

In accordance with the invention, the processors 124 and 126 receive error signals on lines 121 and 123, respectively, used by the processors 124 and 126 to generate control signals used to control the phase shift provided by phase shifters 120 and 127, respectively, to lock the receivers on the incoming signals. The error signals 121 and 123 are generated by detector circuits 128 and 130, respectively, which receive the outputs 113 and 119, respectively, from the EO modulators 112 and 114, respectively, via optical taps 327. The following description will refer to the detector 128 and its associated circuitry, error signal 121, processor 124, phase shifter 120 and EO modulator 112. It will be understood that the description also applies to the function and circuitry of the lower half of system 110 illustrated in FIG. 4.

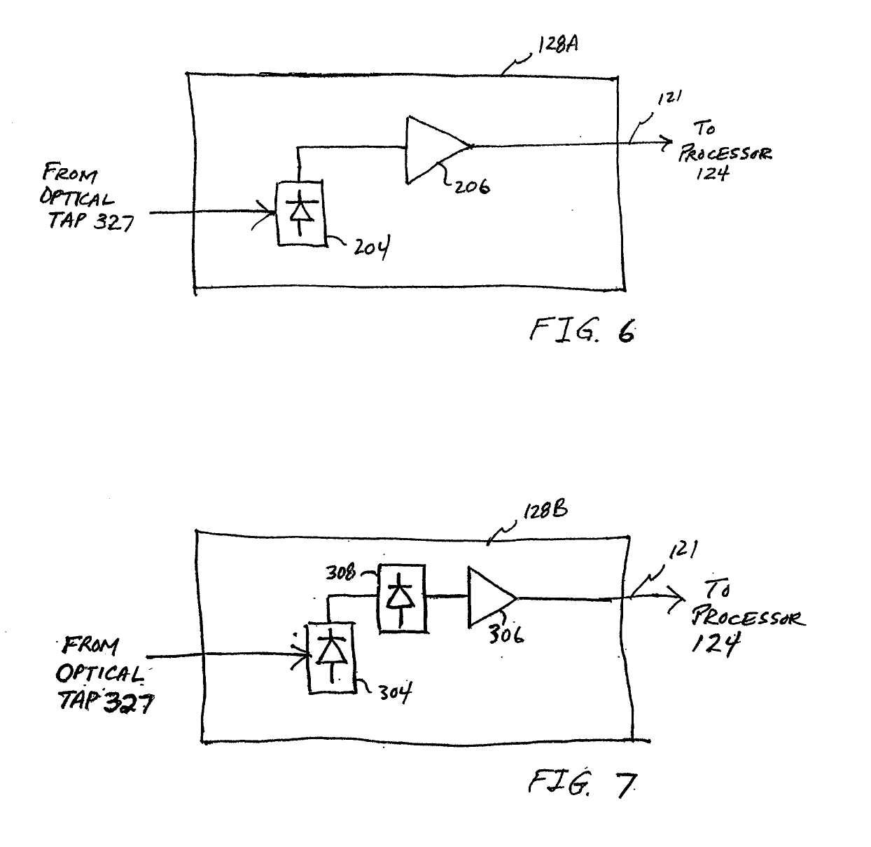

The error signal provided to and used by the feedback processor 124 to alter the phase of the incoming second recovered clock signal via the phase shifter 120 can be generated by one of several different approaches, in accordance with the present invention. FIG. 6 contains a schematic detailed block diagram illustrating details of a first approach. Referring to FIGS. 4 and 6, in one embodiment, a periodic modulation or dither of the phase of the second recovered clock signal is applied by the processor 124. In one embodiment, the period of the dither is very slow, i.e., on the order of 1 kHz. The detector 128A receives the output signal 113 from the EO modulator 112 with this periodic phase dither superimposed. The detector 128A includes a low-speed photodiode 204 which detects the dither frequency on the signal from the optical tap. The output of the photodiode 204 is amplified by a 1 kHz amplifier 206, and the resulting error signal is provided to the processor 124. The error signal provided at line 121 to processor 124 is therefore a version of the slow dither signal as it appears output from the EO modulator 112. The processor adjusts the phase via the phase shifter 120 to minimize or null the level of the detected low-rate dither signal. When the level of the error signal is minimized, then the EO modulator 112 is optimized to provide one of the bit streams at its first output 113 and the other bit stream at its second output 115. In this approach, the processor 124 provides a dual control to the phase shifter 120. It provides the dither signal to periodically vary the phase at a slow rate, and it provides a shift in the phase to null the received dither error signal at the photodiode.

In one particular embodiment, the processor also provides a signal to the bias input of the EO modulator 112 which slightly perturbs the bias of the EO modulator 112 from the quadrature state. This signal perturbs the bias to approximately 90±15 degrees, for example. This ensures that the dither frequency will be superimposed on the output of the EO modulator 112 and provide an error signal to be forwarded to the feedback processor 124.

This first approach provides the capability to generate an accurate useful error signal using relatively inexpensive and simple low-frequency components.

In another embodiment, the error signal provided on line 121 from the detector 128 is a high-frequency error signal derived from the high-frequency output 113 of the EO modulator 112. FIG. 7 contains a schematic detailed block diagram illustrating details of a second approach to generating the error signal in accordance with the invention. Referring to FIGS. 4 and 7, in this embodiment, the slow, e.g., 1 kHz, periodic phase dither is again applied to the phase shifter 120 by the processor 124 to periodically vary the phase of the second recovered clock signal applied to the RF input of the EO modulator 112. The component signal frequency, e.g., 10 GHz, signal is received by the detector 128B via the optical tap 327. A high-frequency, e.g., 10 GHz, photodiode 304 receives the optical signal and converts it to an electrical signal. The electrical signal is then applied to a high-frequency RF detector, which detects the 1 kHz modulation on the high-frequency, i.e., 10 GHz, carrier. The detected signal is amplified at an amplifier 306, and the amplified signal is forwarded to the processor 124. The processor 124 which adjusts the phase of the applied clock signal via phase shifter 120 to minimize or null the 1 kHz modulation and, as a result, maximize the power level of the component-signal-rate, e.g., 10 GHz, signal received by the detector 128B. When the power level of the component-signal-rate signal is maximized, then the EO modulator 112 is optimally tuned to output one of the bit streams on the first output 113 and the other bit stream on the second output 115.

Once again, in this embodiment, the processor 124 provides a dual control to the phase shifter 120. It provides the dither signal to periodically vary the phase at a slow rate, and it provides a shift in the phase to null the received dither error signal to maximize the signal at the high frequency.

In one particular embodiment, the processor also provides a signal to the bias input of the EO modulator 112 which maintains the bias of the EO modulator at quadrature.

This second approach provides very accurate adjustment of the receiver to the high-frequency signal. Also, it is not sensitive to the bias of the EO modulator. The EO modulator can be biased at quadrature. The slight perturbation from quadrature used in the previous embodiment need not be applied under this approach.

In another embodiment, an error signal can be provided to the processor 124, 126 via lines 321, 323, respectively, directly from the output side of the demultiplexing system. The processors 140, 142, 144, 146 can analyze the data received from the receivers 132, 134, 136, 138. Specifically, the error correction processing circuitry 148, 150, 152, 154 in the processors can be used to analyze error detection and correction statistics, such as FEC statistics, to monitor bit error rate (BER). The feedback processors 124 and 126 can adjust the phase of the recovered clock signal via the phase shifter 120 to minimize BER.

In another embodiment, the processors 124, 126 can simultaneously dither the phase via phase shifters 120, 127 at a slow dither rate, which is preferably slower than the 1 kHz rate used in the exemplary illustrative embodiments described above. This introduces a periodic fluctuation in BER, as detected by the FEC processing circuitry. The feedback processors 124, 126 can adjust the phase and the dither to match the periodic fluctuation in BER. The closest match occurs where the EO modulator 112 is optimized to provide one of its input bit streams on its first output 113 and the other of the input bit streams on its output 115. The same description applies to the EO modulator 114.

In general, it is important to direct the individual component bit streams to their corresponding output receivers. That is, bit stream A should be routed to receiver A 132, bit stream B should be routed to receiver B 134, bit stream C should be routed to receiver C 136, and bit stream D should be routed to receiver D 138. It may occur however that in accordance with the foregoing description, the demultiplexing and receiving system 110 may initialize with bit streams being received by incorrect receivers. For example, if the combination of the polarization transformer 102 and PBS 104 does not initialize as desired, bit streams B and D may be output on line 106 and bit streams A and C may be output on line 108. In that case, receivers A and C will receive bit streams B and D, and receivers B and D will receive bit streams A and C. Similarly, even if the polarization transformer 102 initializes properly, the EO modulators 112, 114 may set up such that their outputs are reversed.

In accordance with the invention, each of these error situations can be corrected. The component bit streams can each be encoded with an identifying code such as FEC information which is detected at the output processors 140, 142, 144, 146. If a processor detects that it is not receiving data encoded with the correct identifying code, it can provide a feedback signal on a feedback control line 156, 158, 160, 162 to take corrective action. For example, if the detected identifying code indicates that the polarization transformer 102 and PBS 104 are not routing data appropriately, such as where processor 140 determines that receiver A 132 is receiving data from bit stream B, then a feedback signal is provided on line 156 to line 164 back to the polarization processor 116. To correct the problem, the objective to be accomplished by the processor 116 is the rotation of the polarization of the signals out of the polarization transformer 102 orthogonally or to a state orthogonal to the present state. In one embodiment of the invention, this is accomplished by the processor 116 resetting the polarization transformer 102 such that it will reinitialize and begin generating outputs based on the polarizations. In general, the polarization transformer will initialize randomly such that the probability is about 0.5 that the alternating orthogonal polarizations will be routed to the correct outputs. The reset can be applied as many times as necessary until the polarization transformer 102 sets up properly such that the PBS 104 routes the correct bit streams to the correct PBS outputs.

Similarly, the processors 140, 142, 144, 146 can provide feedback on lines 156, 158, 160, 162, respectively, to the processors 124 and 126, where it is determined that the bit sequences being received are not correct. For example, where processor 140 determines that it is receiving data for bit stream C, it will send a control signal via line 156 and 321 to the processor 124. The processor 124 will shift the phase of the recovered clock signal via the phase shifter by 180 degrees. This will reverse the outputs 113 and 115 such that receiver A 132 will begin receiving bit stream A, and receiver 134 will begin receiving bit stream C.

The demultiplexing receiving system of the invention is a multiple-stage, multiple-mode receiver. Referring again to FIG. 4, in the first stage, which includes the polarization transformer 102, dither signal generator 103, PBS 104 and processor 116, a high-bit-rate, e.g., 40 Gb/sec, signal is received at the PT 102. The received signal is a cross-polarization multiplexed combination of two intermediate-bit-rate, e.g., 20 Gb/s, signals, having orthogonal polarizations. Each of the intermediate-bit-rate signals is a time-multiplexed combination of two component-bit-rate, e.g., 10 Gb/s, signals. In the first stage of the receiver, polarization demultiplexing splits the incoming high-bit-rate signals into the two intermediate-bit-rate signals according to their polarizations, using the polarization beam splitter 104 and the polarization transformer 102, and outputs the signals on lines 106 and 108. This polarization demultiplexing stage is controlled by a clock signal recovered at the output of the polarization demultiplexing stage. This intermediate clock signal, having a frequency at the intermediate bit rate, e.g., 20 GHz, is generated by the clock recovery circuit 118 and is processed to optimize the polarization demultiplexing in the first stage of the receiver. In one embodiment, the 20 GHz component of the recovered intermediate clock signal is maximized by adjusting the polarization transformer 102 receiving the high-bit-rate (40 Gb/s) input signal. When the 20 GHz signal is maximized, the polarization demultiplexing of the first stage is optimized.

The clock recovery circuit 118 can also generate another clock signal used to control the second stage of demultiplexing, i.e., the time demultiplexing. This second recovered clock signal can be a harmonic or sub-harmonic of the clock of the intermediate bit-rate signal. In one embodiment, the second recovered clock signal has a frequency of one-half the bit rate of the intermediate bit-rate input signal, e.g., 10 GHz. This second recovered clock signal is used to adjust the EO modulators 112, 114 in the time-demultiplexing second stage of the receiver. The phase of the second recovered clock signal is adjusted, and the phase-adjusted version of the signal is applied to the RF input of the EO modulators to optimize the time demultiplexing performed in the second stage.

In general, the receiving and demultiplexing system of the invention uses multiple recovered clocks at multiple frequencies. If the frequency of each of the individual component signals is referred to as f, then the frequency of the clock associated with the intermediate-bit-rate signal between the polarization demultiplexing and time demultiplexing stages is Nf, where N is the number of time-multiplexed component signals in a single polarization. The frequency of the clock associated with the high-bit-rate input signal is 2Nf at the input side of the polarization demultiplexing. Therefore, in accordance with the embodiments of the invention described herein, the input bit rate or clock rate to the receiver is 2Nf. After the first stage of demultiplexing, the clock rate or bit rate is Nf. The clock is recovered at this frequency Nf. Next, that clock rate is divided by N to drive the 1×2 EO modulators that do the time demultiplexing, so the clock rate at that point of the demultiplexing is f.

While this invention has been particularly shown and described with references to preferred embodiments thereof, it will be understood by those skilled in the art that various changes in form and details may be made therein without departing from the spirit and scope of the invention as defined by the following claims.

What is claimed is:

1. An apparatus for demultiplexing a multiplexed signal, said multiplexed signal being a combination of a plurality of component signals, each component signal being characterized by a polarization, said apparatus comprising:
an input interface over which the multiplexed signal can be received;
at least one polarization demultiplexer for receiving the multiplexed signal from the input interface and generating therefrom at least one polarization demultiplexed signal of a first polarization; and
a clock recovery circuit for receiving the polarization demultiplexed signal and recovering therefrom a recovered clock signal, the recovered clock signal being used to generate a control signal, the control signal being used to adjust the polarization demultiplexer.

2. The apparatus of claim 1, wherein the multiplexed signal is characterized by a bit rate, the recovered clock signal having a frequency of one-half the bit rate.

3. The apparatus of claim 2, wherein the control signal is generated so as to maximize amplitude of the recovered clock signal.

4. The apparatus of claim 1, wherein the control signal is generated so as to maximize amplitude of the recovered clock signal.

5. The apparatus of claim 1, wherein the control signal is a feedback signal.

6. The apparatus of claim 1, wherein the multiplexed signal is a cross-polarization multiplexed signal.

7. The apparatus of claim 1, wherein a first component signal of the multiplexed signal is characterized by a first polarization and a second component signal of the multiplexed signal is characterized by a second polarization different than the first polarization.

8. The apparatus of claim 1, wherein the multiplexed signal is a time-division multiplexed (TDM) combination of the component signals.

9. The apparatus of claim 8, wherein adjacent component signals within the TDM signal have different polarizations.

10. The apparatus of claim 8, wherein adjacent component signals within the TDM signal have orthogonal polarizations.

11. The apparatus of claim 1, wherein the polarization demultiplexer comprises a polarization beam splitter.

12. The apparatus of claim 1, wherein the polarization demultiplexer comprises a polarization transformer.

13. The apparatus of claim 12, wherein the polarization transformer comprises a plurality of cascaded retardation waveplates.

14. The apparatus of claim 1, wherein the polarization demultiplexer generates a pair of polarization demultiplexed signals.

15. The apparatus of claim 1, further comprises a time demultiplexer for receiving the polarization demultiplexed signal and generating therefrom at least one time and polarization demultiplexed signal.

16. The apparatus of claim 15, wherein the at least one time and polarization demultiplexed signal is a recovered version of one of the component signals.

17. The apparatus of claim 15, wherein the time demultiplexer comprises at least one electro-optical (EO) modulator for generating the at least one time and polarization demultiplexed signal.

18. The apparatus of claim 17 wherein the polarization demultiplexed signal is aligned to the input of the EO modulator.

19. The apparatus of claim 17, wherein the EO modulator is a 1×2 modulator having one input and two outputs.

20. The apparatus of claim 17, wherein the EO modulator comprises an RF input, a phase-adjusted version of the recovered clock signal being applied to the RF input.

21. The apparatus of claim 20, further comprising an error signal generating device for receiving the at least one time and polarization demultiplexed signal and generating an error signal used to adjust the phase of the phase-adjusted version of the recovered clock signal.

22. The apparatus of claim 20, wherein the phase of the recovered clock signal is dithered to produce the phase-adjusted version of the clock signal.

23. The apparatus of claim 17, wherein the EO modulator comprises an RF input, a phase-adjusted version of a sub-harmonic of the recovered clock signal being applied to the RF input.

24. The apparatus of claim 23, further comprising an error signal generating device for receiving the at least one time and polarization demultiplexed signal and generating an error signal used to adjust the phase of the phase-adjusted version of the sub-harmonic of the recovered clock signal.

25. The apparatus of claim 23, wherein the phase of the recovered clock signal is dithered to produce the phase-adjusted version of the sub-harmonic of the clock signal.

26. The apparatus of claim 17, wherein the EO modulator comprises an RF input, a phase-adjusted version of a harmonic of the recovered clock signal being applied to the RF input.

27. The apparatus of claim 26, further comprising an error signal generating device for receiving the at least one time and polarization demultiplexed signal and generating an error signal used to adjust the phase of the phase-adjusted version of the harmonic of the recovered clock signal.

28. The apparatus of claim 26, wherein the phase of the recovered clock signal is dithered to produce the phase-adjusted version of the harmonic of the clock signal.

29. The apparatus of claim 17, wherein the EO modulator comprises a bias input, a bias signal applied to the bias input perturbing the bias of the EO modulator from quadrature.

30. An apparatus for demultiplexing a multiplexed signal, said multiplexed signal being a combination of a plurality of component signals, each component signal being characterized by a polarization, said apparatus comprising:
an input interface over which the multiplexed signal can be received;
a polarization demultiplexing stage for receiving the multiplexed signal from the input interface and generating therefrom at least one polarization demultiplexed signal of a first polarization; and
a time demultiplexing stage for receiving the at least one polarization demultiplexed signal and time demultiplexing the polarization demultiplexed signal to generate at least one time and polarization demultiplexed signal.

31. The apparatus of claim 30, further comprising a clock recovery circuit for receiving the polarization demultiplexed signal and recovering therefrom a recovered clock signal, the recovered clock signal being used to generate a control signal, the control signal being used to adjust the polarization demultiplexer.

32. The apparatus of claim 31, wherein the control signal is generated so as to maximize amplitude of the recovered clock signal.

33. The apparatus of claim 30, wherein the control signal is generated so as to maximize amplitude of the recovered clock signal.

34. The apparatus of claim 30, wherein the control signal is a feedback signal.

35. The apparatus of claim 30, wherein the multiplexed signal is characterized by a bit rate, the recovered clock signal having a frequency of one-half the bit rate.

36. The apparatus of claim 29, wherein the multiplexed signal is a cross-polarization multiplexed signal.

37. The apparatus of claim 36, wherein a first component signal of the multiplexed signal is characterized by a first polarization and a second component signal of the multiplexed signal is characterized by a second polarization different than the first polarization.

38. The apparatus of claim 30, wherein the multiplexed signal is a time-division multiplexed (TDM) combination of the component signals.

39. The apparatus of claim 30, wherein the polarization demultiplexing stage comprises a polarization beam splitter.

40. The apparatus of claim 30, wherein the polarization demultiplexing stage comprises a polarization transformer.

41. The apparatus of claim 40, wherein the polarization transformer comprises a plurality of cascaded retardation waveplates.

42. The apparatus of claim 30, wherein the polarization demultiplexing stage generates a pair of polarization demultiplexed signals.

43. The apparatus of claim 30, wherein the at least one time and polarization demultiplexed signal is a recovered version of one of the component signals.

44. The apparatus of claim 38, wherein adjacent component signals within the TDM signal have different polarizations.

45. The apparatus of claim 38, wherein adjacent component signals within the TDM signal have orthogonal polarizations.

46. The apparatus of claim 30, wherein the time demultiplexing stage comprises at least one electro-optical (EO) modulator for generating the at least one time and polarization demultiplexed signal.

47. The apparatus of claim 46, wherein the polarization demultiplexed signal is aligned to the input of the EO modulator.

48. The apparatus of claim 46, wherein the EO modulator is a 1×2 modulator having one input and two outputs.

49. The apparatus of claim 46, wherein the EO modulator comprises an RF input, a phase-adjusted version of the recovered clock signal being applied to the RF input.

50. The apparatus of claim 49, further comprising an error signal generating device for receiving the at least one time and polarization demultiplexed signal and generating an error signal used to adjust the phase of the phase-adjusted version of the recovered clock signal.

51. The apparatus of claim 49, wherein the phase of the recovered clock signal is dithered to produce the phase-adjusted version of the clock signal.

52. The apparatus of claim 46, wherein the EO modulator comprises an RF input, a phase-adjusted version of a sub-harmonic of the recovered clock signal being applied to the RF input.

53. The apparatus of claim 52, further comprising an error signal generating device for receiving the at least one time and polarization demultiplexed signal and generating an error signal used to adjust the phase of the phase-adjusted version of the sub-harmonic of the recovered clock signal.

54. The apparatus of claim 52, wherein the phase of the recovered clock signal is dithered to produce the phase-adjusted version of the sub-harmonic of the clock signal.

55. The apparatus of claim 46, wherein the EO modulator comprises an RF input, a phase-adjusted version of a harmonic of the recovered clock signal being applied to the RF input.

56. The apparatus of claim 55, further comprising an error signal generating device for receiving the at least one time and polarization demultiplexed signal and generating an error signal used to adjust the phase of the phase-adjusted version of the harmonic of the recovered clock signal.

57. The apparatus of claim 53, wherein the phase of the recovered clock signal is dithered to produce the phase-adjusted version of the harmonic of the clock signal.

58. An apparatus for demultiplexing a multiplexed signal, said multiplexed signal being a combination of a plurality of component signals, each component signal being characterized by a polarization and including a data signal pattern, said apparatus comprising:
an input interface over which the multiplexed signal can be received;
at least one polarization demultiplexer for receiving the multiplexed signal from the input interface and generating therefrom at least one polarization demultiplexed signal of a first polarization; and
at least one receiver associated with one of a plurality of data signal patterns, the receiver analyzing the data signal pattern of a component signal recovered from the multiplexed signal to determine if the data signal pattern matches the data signal pattern associated with the at least one receiver, the at least one receiver providing a feedback signal indicative of whether the analyzed data signal pattern matches the data signal pattern associated with the at least one receiver, the feedback signal being used to adjust the polarization demultiplexer if the analyzed data signal pattern does not match the data signal pattern associated with the at least one receiver.

59. The apparatus of claim 58, wherein the adjustment of the polarization demultiplexer if the analyzed data signal pattern does not match the data signal pattern associated with the at least one receiver includes rotating the polarization of the at least one polarization demultiplexed signal to an orthogonal state.

60. The apparatus of claim 58, further comprising a clock recovery circuit for receiving the polarization demultiplexed signal and recovering therefrom a clock signal, the clock signal being used to generate a control signal, the control signal being used to adjust the polarization demultiplexer.

61. The apparatus of claim 58, further comprising a time demultiplexer for receiving the polarization demultiplexed signal and generating therefrom at least one time and polarization demultiplexed signal.

62. The apparatus of claim 61, wherein the at least one time and polarization demultiplexed signal is a recovered version of one of the component signals.

63. The apparatus of claim 61, wherein the time demultiplexer comprises at least one electro-optical (EO) modulator for generating the at least one time and polarization demultiplexed signal.

64. The apparatus of claim 63, further comprising a clock recovery circuit for receiving the polarization demultiplexed signal and recovering therefrom a clock signal, the clock signal being used to generate a control signal, the control signal being used to adjust the polarization demultiplexer.

65. The apparatus of claim 64, wherein the EO modulator comprises an RF input, a phase-adjusted version of the clock signal being applied to the RF input.

66. The apparatus of claim 65, wherein, if the analyzed data signal pattern does not match the data signal pattern associated with the at least one receiver, the phase of the clock signal applied to the RF input is adjusted 180 degrees.

67. An apparatus for demultiplexing a multiplexed signal, said multiplexed signal being a combination of a plurality of component signals, each component signal being characterized by a polarization, said apparatus comprising:
an input interface over which the multiplexed signal can be received;
a clock recovery circuit for receiving the multiplexed signal and recovering therefrom a clock signal;
an electro-optical modulator for receiving the multiplexed signal and generating at least one demultiplexed signal therefrom, the electro-optical modulator including an RF input and a bias input, the RF input receiving a phase-adjusted version of the clock signal;
a detector circuit for detecting the at least one demultiplexed signal from the electro-optical modulator and generating therefrom an error signal; and
a processor for receiving the error signal from the detector circuit and generating a control signal based on the error signal, the control signal being used to adjust the phase of the clock signal applied to the RF input of the electro-optical modulator.

68. The apparatus of claim 67, wherein the error signal is a signal having a frequency equal to a data rate of the demultiplexed signal.

69. The apparatus of claim 68, wherein the control signal is generated to adjust the phase of the clock signal to maximize a portion of the error signal at the data rate of the demultiplexed signal.

70. The apparatus of claim 67, wherein the phase of the clock signal applied to the RF input of the electro-optical modulator is periodically varied at a dither rate.

71. The apparatus of claim 70, wherein the control signal is generated to adjust the phase of the clock signal to minimize a portion of the error signal that is at the dither rate.

72. The apparatus of claim 67, wherein the control signal is generated to adjust the phase of the clock signal to optimize an attribute of the demultiplexed signal.

73. The apparatus of claim 72, wherein the attribute is error rate in the demultiplexed signal.

74. The apparatus of claim 72, wherein the optimization is done by decoding information in the demultiplexed signal.

75. The apparatus of claim 74, wherein the decoded information is error correction information.

76. The apparatus of claim 74, wherein the decoded information is forward error correction (FEC) information.

77. A method of demultiplexing a multiplexed signal, said multiplexed signal being a combination of a plurality of component signals, each component signal being characterized by a polarization, said method comprising:
receiving the multiplexed signal over an interface;
receiving the multiplexed signal from the input interface and generating therefrom at least one polarization demultiplexed signal of a first polarization; and
receiving the polarization demultiplexed signal and recovering therefrom a recovered clock signal, the recovered clock signal being used to generate a control signal, the control signal being used to adjust the polarization demultiplexer.

78. A method of demultiplexing a multiplexed signal, said multiplexed signal being a combination of a plurality of component signals, each component signal being characterized by a polarization, said method comprising:
receiving the multiplexed signal over an interface;
receiving the multiplexed signal from the input interface and generating therefrom at least one polarization demultiplexed signal of a first polarization; and
receiving the at least one polarization demultiplexed signal and time demultiplexing the polarization demultiplexed signal to generate at least one time and polarization demultiplexed signal.

79. A method of demultiplexing a multiplexed signal, said multiplexed signal being a combination of a plurality of component signals, each component signal being characterized by a polarization and including a data signal pattern, said method comprising:
receiving the multiplexed signal over an interface;
receiving the multiplexed signal from the input interface and generating therefrom at least one polarization demultiplexed signal of a first polarization; and
providing at least one receiver associated with one of a plurality of data signal patterns, the receiver analyzing the data signal pattern of a component signal recovered from the multiplexed signal to determine if the data signal pattern matches the data signal pattern associated with the at least one receiver, the at least one receiver providing a feedback signal indicative of whether the analyzed data signal pattern matches the data signal pattern associated with the at least one receiver, the feedback signal being used to adjust the polarization demultiplexer if the analyzed data signal pattern does not match the data signal pattern associated with the at least one receiver.

80. A method of demultiplexing a multiplexed signal, said multiplexed signal being a combination of a plurality of component signals, each component signal being characterized by a polarization, said method comprising:
receiving the multiplexed signal over an interface;
receiving the multiplexed signal and recovering therefrom a clock signal;
providing an electro-optical modulator for receiving the multiplexed signal and generating at least one demultiplexed signal therefrom, the electro-optical modulator including an RF input and a bias input, the RF input receiving a phase-adjusted version of the clock signal;
providing a detector circuit for detecting the at least one demultiplexed signal from the electro-optical modulator and generating therefrom an error signal; and
providing a processor for receiving the error signal from the detector circuit and generating a control signal based on the error signal, the control signal being used to adjust the phase of the clock signal applied to the RF input of the electro-optical modulator.
